(19) United States
(12) Patent Application Publication
(10) Pub. No.: US 2024/0420356 A1
(43) Pub. Date: Dec. 19, 2024

(54) METHOD AND SYSTEM FOR DEPTH ESTIMATION USING GATED STEREO IMAGING

(71) Applicant: Torc Robotics, Inc., Blacksburg, VA (US)

(72) Inventors: Felix Heide, New York City, NY (US); Fahim Mannan, Ontario (CA); Mario Bijelic, Frankfurt (DE)

(21) Appl. No.: 18/743,696

(22) Filed: Jun. 14, 2024

Related U.S. Application Data
(60) Provisional application No. 63/508,776, filed on Jun. 16, 2023.

(51) Int. Cl. G06T 7/593; G01S 17/89

(52) U.S. Cl. CPC G06T 7/593; G01S 17/89; G06T 2207/10012; G06T 2207/20228

(57) ABSTRACT

A perception system including at least one memory, and at least one processor configured to: (i) compute, in a stereo branch, disparity from a pair of stereo images including a left image and a right image; (ii) based on the computed disparity from the pair of stereo images, output, by the stereo branch, a depth for the left image and a depth for the right image; (iii) compute an absolute depth for the left image in a first monocular branch and an absolute depth for the right image in a second monocular branch; (iv) compute, in a first fusion branch, a depth map for the left image; (v) compute, in a second fusion branch, a depth map for the right image; and (vi) generate a single fused depth map based on the depth map for the left image and the depth map for the right image, is disclosed.

### CROSS-REFERENCE TO RELATED APPLICATIONS

This application claims priority to U.S. Provisional Patent Application No. 63/508,776, filed Jun. 16, 2023, entitled “DEPTH ESTIMATION FOR AUTONOMOUS VEHICLES USING GATED STEREO IMAGING,” the entire content of which is hereby incorporated by reference in its entirety.

### TECHNICAL FIELD

The field of the disclosure relates generally to autonomous vehicle and, more specifically, to systems and methods for providing depth estimation using gated stereo imaging.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One element of perception for autonomous vehicles is depth estimation, which is critical for navigation and obstacle avoidance, among other operations. Performance of at least some known depth estimation solutions in generally limited in range, spatial resolution, or scale ambiguity, or performance is impacted by environmental conditions, such as, for example, low-light, low texture surfaces, strong ambient light, or adverse weather, among other conditions.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a perception system including a plurality of image sensors, at least one memory having instructions stored thereon, and at least one processor communicatively coupled with the at least one memory is disclosed. The at least one processor is configured to execute the instructions to: (i) compute, in a stereo branch, disparity from a pair of stereo images including a left image and a right image, wherein the left image and the right image are generated based on sensor data of the plurality of image sensors; (ii) based on the computed disparity from the pair of stereo images, output, by the stereo branch, a depth for the left image and a depth for the right image; (iii) compute an absolute depth for the left image in a first monocular branch and an absolute depth for the right image in a second monocular branch; (iv) compute, in a first fusion branch, a depth map for the left image by combining a depth output for the left image from the stereo branch and the absolute depth for the left image from the first monocular branch; (v) compute, in a second fusion branch, a depth map for the right image by combining a depth output for the right image from the stereo branch and the absolute depth for the right image from the second monocular branch; and (vi) generate a single fused depth map based on the depth map for the left image computed in the first fusion branch and the depth map for the right image computed in the second fusion branch.

In another aspect, a computer-implemented method is disclosed. The computer-implemented method includes (i) computing, in a stereo branch, disparity from a pair of stereo images including a left image and a right image, wherein the left image and the right image are generated based on sensor data of the plurality of image sensors; (ii) based on the computed disparity from the pair of stereo images, outputting, by the stereo branch, a depth for the left image and a depth for the right image; (iii) computing an absolute depth for the left image in a first monocular branch and an absolute depth for the right image in a second monocular branch; (iv) computing, in a first fusion branch, a depth map for the left image by combining a depth output for the left image from the stereo branch and the absolute depth for the left image from the first monocular branch; (v) computing, in a second fusion branch, a depth map for the right image by combining a depth output for the right image from the stereo branch and the absolute depth for the right image from the second monocular branch; and (vi) generating a single fused depth map based on the depth map for the left image computed in the first fusion branch and the depth map for the right image computed in the second fusion branch.

In yet another aspect, a vehicle including a plurality of image sensors, at least one memory having instructions stored thereon, and at least one processor communicatively coupled with the at least one memory is disclosed. The at least one processor is configured to execute the instructions to: (i) compute, in a stereo branch, disparity from a pair of stereo images including a left image and a right image, wherein the left image and the right image are generated based on sensor data of the plurality of image sensors; (ii) based on the computed disparity from the pair of stereo images, output, by the stereo branch, a depth for the left image and a depth for the right image; (iii) compute an absolute depth for the left image in a first monocular branch and an absolute depth for the right image in a second monocular branch; (iv) compute, in a first fusion branch, a depth map for the left image by combining a depth output for the left image from the stereo branch and the absolute depth for the left image from the first monocular branch; (v) compute, in a second fusion branch, a depth map for the right image by combining a depth output for the right image from the stereo branch and the absolute depth for the right image from the second monocular branch; and (vi) generate a single fused depth map based on the depth map for the left image computed in the first fusion branch and the depth map for the right image computed in the second fusion branch.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawings will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is an example setup of stereo gated cameras including two gated cameras and a single flood-lit illumination source;

FIG. 5 is an example architecture including a stereo, two monocular and two fusion networks;

FIG. 6 is an example illustration of scene regions occluded in an illuminator view;

FIG. 7A is an example sensor setup;

FIG. 7B illustrates example captures from a wide-base gated stereo dataset;

FIG. 8 is an example representation of qualitative comparison of gated stereo;

FIG. 9 is an example representation of quantitative results showing comparison between known state-of-the-art methods and gated stereo method according to some embodiments;

FIG. 10 is an example view showing active and passive images;

FIG. 11 is an example table showing results from ablation experiments; and

FIG. 12 is an example flow-chart of method operations to perform depth estimation using fusion of gated stereo and monocular networks.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Various embodiments described herein correspond with systems and methods for depth estimation determination using gated stereo observations based upon both multi-view and time-of-flight cues to generate high-resolution depth maps. The depth estimation determination may be performed using a depth reconstruction network including a monocular depth network per gated camera and a stereo network that utilizes both active and passive slices from the gated stereo pair. A monocular network uses depth-dependent gated intensity cues to estimate depth in monocular and low-light regions. The stereo network uses active stereo cues. Both the monocular network and stereo network branches are combined in a learned fusion step. Using passive slices enables robust performance under bright daylight where active cues have a low signal-to-noise ratio (SNR) due to ambient illumination. The depth reconstruction network is trained with supervised and self-supervised losses tailored to the stereo-gated configuration including, ambient-aware and illuminator-aware consistency along with multi-camera consistency. An autonomous vehicle may capture training data including, capturing a stereo-gated dataset under different lighting conditions and automotive driving scenarios in urban, suburban, and highway environments across many thousands of kilometers of driving.

In some embodiments, the disclosed systems and methods include a depth estimation technique using gated stereo images that generate high-resolution dense depth maps from multi-view and time-of-flight depth cues. Additionally, a depth estimation network with two different branches for depth estimation, e.g., a monocular branch and a stereo branch. The depth estimation network may use active and passive measurements, and a semi-supervised training scheme to train an estimator.

In some embodiments, a vehicle, e.g., an autonomous vehicle, including a plurality of sensors, e.g., at least two synchronized gated cameras, for perceiving the environment around the vehicle. The vehicle includes a perception system including at least one processor for detecting objects or obstacles in the environment of the vehicle based upon data from the plurality of sensors. Additionally, or alternatively, based upon the data from the plurality of sensors, relative locations or velocities of objects, and judgments about future states or actions of the objects. Environmental perception includes depth estimation and may be based at least in part upon collected image data from, for example, light detection and ranging (LiDAR) sensors, radio detection and ranging (RADAR) sensors, visual or red-green-blue (RGB) cameras, sonar sensors, ultrasonic sensors, etc., among other suitable active or passive cameras.

In some embodiments, a vehicle, e.g., an autonomous vehicle, including one or more processors or processing system configured to perform a localization function is disclosed. Localization is the process of determining the precise location of the autonomous vehicle using data from the perception system and data from other systems, such as a global navigation satellite system (GNSS) (e.g., a global positioning system (GPS) or an inertial measurement unit (IMU). The autonomous vehicle's position, both absolute and

relative to other objects in the environment, is used for global and local mission planning, as well as for other auxiliary functions, such as determining expected weather conditions or
other environmental considerations based on externally generated data.

In some embodiments, a vehicle, e.g., an autonomous vehicle, including one or more processors or processing system configured to perform behaviors planning and control function is disclosed. Behaviors planning and control includes planning and implementing one or more behavioral-based trajectories to operate an autonomous vehicle similar to a human driver-based operation. The behaviors planning and control system uses inputs from the perception system or localization system to generate trajectories or other actions that may be selected to follow or enact as the autonomous vehicle travels. Trajectories may be generated based on known appropriate interaction with other static and dynamic objects in the environment, e.g., those indicated by law, custom, or safety. The behaviors planning and control system may also generate local objectives including, for example, lane changes, obeying traffic signs, etc.

The Gated Stereo referenced in the present disclosure is a high-resolution and long-range depth estimation technique that operates on active gated stereo images. Using active and high dynamic range passive captures, the Gated Stereo exploits multi-view cues alongside time-of-flight intensity cues from active gating. Accordingly, in some embodiments, a depth estimation method with a monocular and stereo depth prediction branch are combined in a final fusion stage. Each block is supervised through a combination of supervised and gated self-supervision losses. Additionally, to facilitate training and validation, a long-range synchronized gated stereo dataset for automotive scenarios may be acquired. By way of a non-limiting example, the depth estimation technique described in the present disclosure may achieve an improvement of about more than 50% mean absolute error (MAE) in comparison with the next best RGB stereo method, and about more than 74% MAE to existing monocular gated methods for distances, for example, up to 160 meters.

Long-range high-resolution depth estimation is critical for autonomous drones, robotics, and driver assistance systems. Most currently known fully autonomous vehicles strongly rely on scanning LiDAR sensors for depth estimation. While the LiDAR sensors are effective for obstacle avoidance, the measurements are often not as semantically rich as RGB images. Further, LiDAR sensing also has to make trade-offs due to physical limitations, especially beyond 100 meters range, including range, range versus eye-safety, and spatial resolution. Although, recent advances in LiDAR sensors such as, micro-electro-mechanical system (MEMS) scanning and photodiode technology, have drastically reduced cost and led to a number of sensor designs with about 100 to 200 scanlines. However, even with these number of scanlines, resolution is significantly lower that modern high dynamic range (HDR) megapixel camera sensors with a vertical resolution of more than about 5000 pixels. However, extracting depth from RGB images with monocular methods is challenging as existing estimation methods suffer from a fundamental scale ambiguity. Stereo-based depth estimation methods resolve this issue of low resolution with well calibrated sensor systems, but still fail in texture-less regions and in poor lighting conditions. For example, in poor lighting conditions, no reliable features such as, a triangulation candidate, can be found.

To overcome limitations of existing scanning LiDAR and RGB stereo depth estimation methods, Gated Imaging as described in the present disclosure may be used. Gated imagers integrate a transient response from a flash-illuminated scene in broad temporal bins. The Gated Imaging technique is robust to low-light, and adverse weather conditions (e.g., fog, rain, snow, etc.) and the embedded time-of-flight information is decoded as depth. Depth from three gated slices is estimated and predicted through a combination of simulation and LiDAR supervision. For example, a self-supervised training approach is used to predict higher-quality depth maps. However, the currently known Gated Imaging techniques often fail in conditions where the SNR is low, e.g., in the case of strong ambient light.

Accordingly, various embodiments in the present disclosure describe a depth estimation method from gated stereo observations that are based upon both multi-view and time-of-flight cues to estimate high-resolution depth maps. Additionally, a depth reconstruction network that includes a monocular depth network per gated camera and a stereo network that utilizes both active and passive slices from the gated stereo pair. The monocular depth network may use depth-dependent gated intensity cues to estimate depth in monocular and low-light conditions or low-light regions, and the stereo depth network relies on active stereo cues. Both network branches are fused in a learned fusion block. Passive slices are used for robust depth estimation under bright daylight where active cues have a low SNR due to ambient light or illumination, Additionally, the depth reconstruction network may be trained using supervised and self-supervised losses that are tailed to the stereo-gated setup including ambient-aware and illuminator-aware consistency along with multi-camera consistency. The depth reconstruction network may be trained using a training dataset acquired using a custom prototype vehicle under different lighting conditions and in urban, suburban and highway environments across, for example, thousands of kilometers of driving.

Depth from Time-of-Flight

Time-of-Flight sensors acquire depth by estimating the ground travel time of light emitted into a scene and returned to the detector. Broadly adopted approaches to Time-of-Flight sensing include correlation time of flight cameras, pulsed Time-of-Flight sensors, and gated illumination with wide depth measuring bins. Correlation Time-of-Flight sensors flood-illuminate a scene and estimate the depth from the phase difference of the emitted and received light, which allows for precise depth estimation with high spatial resolution but due to its sensitivity to ambient light, existing correlation Time-of-Flight detectors are limited to indoor applications. In contrast, pulsed light Time-of-Flight systems measure the roundtrip time directly from a single light pulse emitted to a single point in the scene. Although, a single point measurement offers high depth precision and SNR, the acquisition process mandates scanning to allow long outdoor distances and, as such, drastically reduces spatial resolution in dynamic scenes. Additionally, pulsed LiDAR measurements drastically degrade in adverse weather conditions due to backscattered light, for example, from snow or fog. Gated cameras accumulate flood-illuminated light over short temporal bins limiting the visible scene to certain depth ranges. As a result, gated cameras gate-out backscatter and at short range and reconstruct coarse depth.

Depth Estimation from Monocular and Stereo Intensity Images

Depth estimation from single images, single images with sparse LiDAR points, stereo image pairs, or stereo with sparse LiDAR points is explored, and in particular, monocular depth imaging approaches offer low cost when a single complementary metal oxide semiconductor (CMOS) camera is used. Additionally, footprint is reduced compared to LiDAR systems when applied across application domains. However, monocular depth estimation methods inherit a fundamental scale ambiguity problem that can be resolved by vehicle speed or LiDAR ground-truth depth measurements at test time. Stereo approaches, on the other hand, allow triangulating between two different views resolving the scale ambiguity. As a result, these methods allow for accurate long-range depth prediction when active sensors are not present. To learn depth prediction from stereo intensity images, currently known methods employ supervised and unsupervised learning techniques. Supervised stereo techniques often rely on Time-of-Flight data or multi-view data for supervision. As a result, the collection of suitable dense ground-truth data can be challenging. To compensate for the sparsity of LiDAR ground-truth measurements through ego-motion correction and acquisition of multiple point clouds. Moreover, such aggregated LiDAR ground-truth depth is incorrect in scattering media. To tackle this challenge and exploit large datasets of video data without ground-truth LiDAR depth present, self-supervised stereo approaches exploit multi-view geometry by aligning stereo image pairs or use image view synthesis between temporally consecutive frames. Further, the depth estimation network is trained to predict disparities from monocular camera images by encouraging consistency when warped to stereo images and warping temporally consecutive stereo captures. By way of a non-limiting example, warping may be performed using two networks in which one network predicts the depth and the second network predicts a rigid body transformation between two temporally adjacent frames. Depth estimation network may be based on diverse neural network architectures and extensions in the loss formulation. Recurrent all-pairs field transforms-stereo (RAFT-stereo), which is a type of deep neural network, relies on iterative refinement over the cost volume at high resolution, which are memory and computationally intensive tasks. RAFT-stereo benefits from construction of a lighter cost volume and 2D convolution instead of 3D convolutions. Depth estimation methods, which are based on passive imaging, generally fail in poor-light or low-contrast scenarios that active gated methods tackle using illumination. Alternate approaches of depth estimation employ sparse LiDAR measurements not only for supervised training algorithms but also during inference time to overcome the scale ambiguity from monocular approaches, which suffer from temporal LiDAR distortions and scan pattern artefacts are passed through.

Depth Estimation from Gated Images

Gated depth estimation methods with analytical solutions guiding the depth estimation includes learned Bayesian approaches and deep neural networks that have achieved dense depth estimation at long-range outdoor scenarios and in low-level environments. While the currently known depth estimation methods rely on monocular gated imaging systems, which are similar to passive color stereo approaches. A fully supervised depth prediction network leverages pretrained on fully synthetic data performing on par with traditional stereo approaches. A self-supervised gated depth estimation method, while resolves scale ambiguity, still suffers in bright daylight in the absence of depth cue, and at long ranges due to depth quantization and lack of relative motion during training.

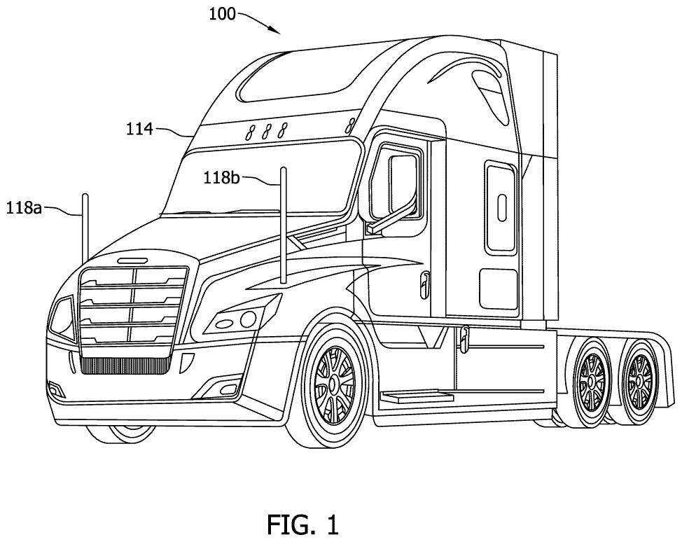

In some embodiments, various issues described herein are solved using a wide-baseline stereo-gated camera to estimate accurate depth in all different types of illumination conditions or scenarios and at long ranges. Various embodiments in the present disclosure are described with reference to FIGS. 1-12 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

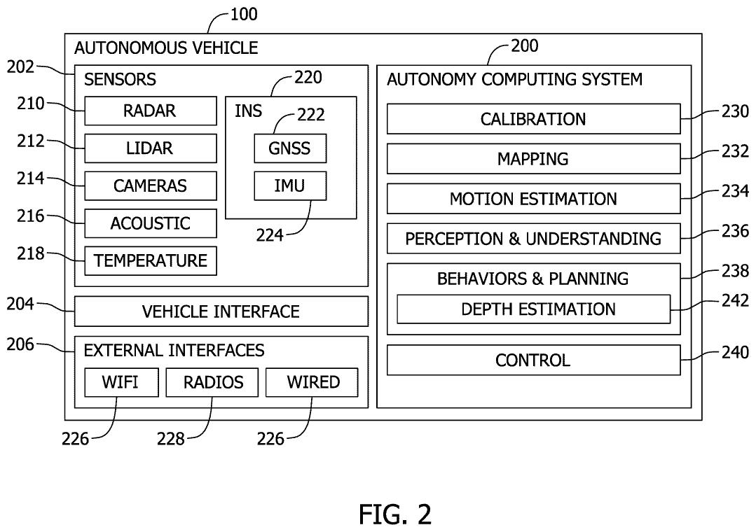

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed for 3D objects detection in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination in perception technologies of autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, 6G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a depth estimation module 242. The depth estimation module 242, for example, may be embodied within another module, such as behaviors and planning module 238, or perception and understanding module 236, or separately. These modules may be implemented in dedicated hardware such as, for example, an application specific integrated circuit (ASIC), field programmable gate array (FPGA), a digital signal processor (DSP), or microprocessor, or implemented as executable software modules, or firmware, written to memory and executed on one or more processors onboard autonomous vehicle 100.

The depth estimation module 242 may perform depth estimation based upon sensor data of gated stereo imaging sensors in different lighting conditions or scenarios including poor lighting conditions and in adverse weather conditions (e.g., fog, rain, snow, etc.) and at short and long ranges.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

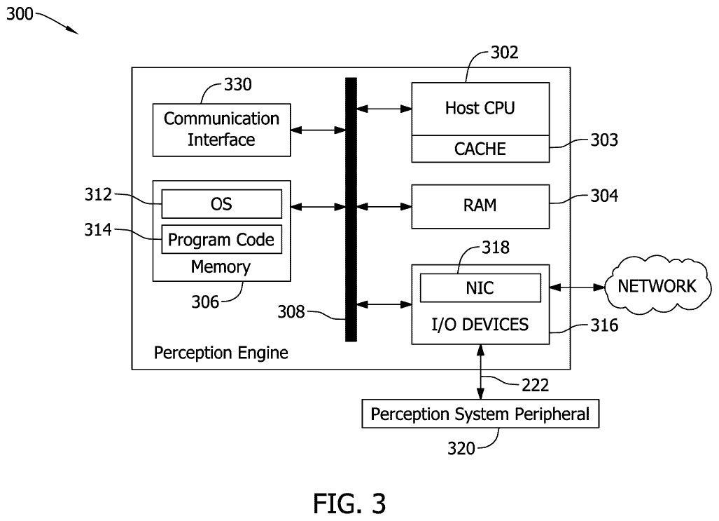

FIG. 3 is a block diagram of an example computing system 300, such as an application server at a hub. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, one or more weight sensors, a keyboard, or a display device, etc.

### Gated Stereo Imaging

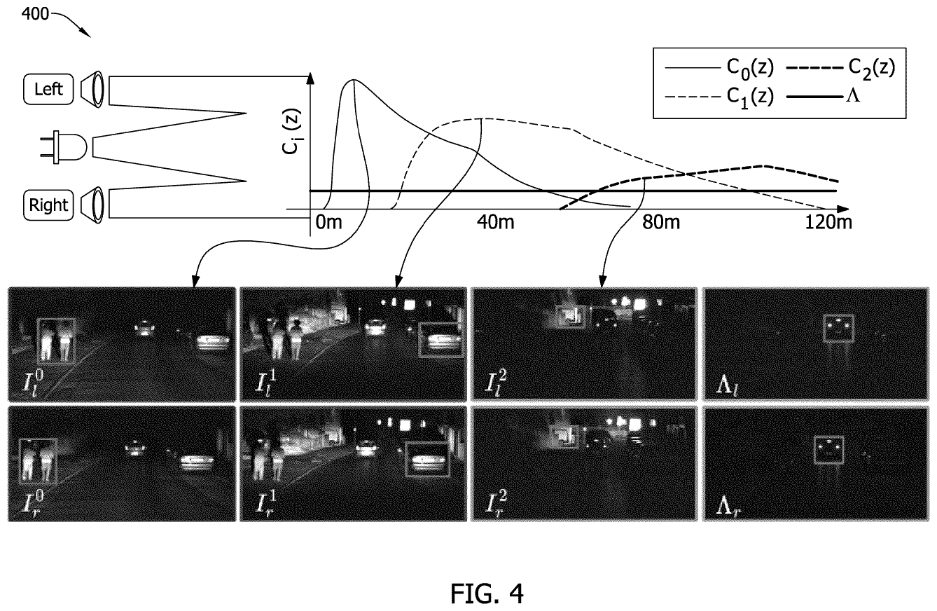

FIG. 4 is an example setup 400 of stereo gated cameras including two gated cameras and a single flood-lit pulsed illumination source. As described herein, environment perception for autonomous drones and vehicles requires precise depth sensing for safety-critical control decisions. In some embodiments, two gated stereo cameras, e.g., a synchronized gated camera setup, with a wide baseline of b of 0.76 m may be used for capturing three synchronized gated and passive slices. Synchronizing two gated stereo cameras requires not only the trigger of individual single exposures as for traditional stereo cameras, but the transfer of gate information for each slice with nano-second accuracy is also required, which allows to extract slices with gated multi-view cues.

In some embodiments, after emitting a laser pulse p at time t=0, the reflection of the scene gets integrated on both camera sensors after a predefined time delay ξ identical on both cameras of the synchronized gated stereo camera setup. Varying the delay between illumination and the synchronized cameras results in different range-intensity profiles cₖ describing the pixel-intensity for distance z for each camera in addition to disparity d. As shown in FIG. 4, for image information in bright airlight, an additional passive component A may be required. Resulting images for left and right camera positions illustrating gating and parallax in an example scene are shown in FIG. 4 in the bottom section.

Photons arriving in a given temporal gate are captured with a gate function g allowing to integrate implicit depth information into 2D images. The distance-dependent pixel intensities may be described by range-intensity-profiles cₖ(z) that are independent of the scene and presented as,

$${I}^{k} ( z , t ) = α {c}_{k} ( z , t ) = α {\int }_{- ∞}^{∞} {g}_{k} ( t - ξ ) {p}_{k} ( t - \frac{2 z}{c} ) β ( z ) dt , \qquad Eq . 1$$

In Eq. 1 above, I^{k}(z, t) is the gated exposure, indexed by k for the slice index at distance z and time t, and α is the surface reflectance (albedo) and β is the attenuation along a given path due to atmospheric effects. Both image stacks are rectified and calibrated such that epipolar lines in both cameras are aligned along the image width and disparities d can be estimated. Epipolar disparity is consistent with the distance

$$z = \frac{bf}{d} ,$$

where f is the focal length providing a depth cue across all modulated and unmodulated slices.

In the present of ambient light or other light sources such as, sunlight or vehicle headlamps, unmodulated photons are acquired as a constant Λ and added to Eq. 1 above as,

$${I}^{k} ( z ) = α {c}_{k} ( z ) + Λ , \qquad Eq . 2$$

Independently from ambient light, a dark current Dᵥ^{k} depending on the gate setting may be added to the intensity count as,

$${I}_{v}^{k} ( z ) = α {c}_{k} ( z ) + Λ + {D}_{v}^{, k} , \qquad Eq . 3$$

Eq. 3 above calibrate for each gate k and camera v. The Poisson-Gaussian noise model may be adopted, and two unmodulated passive exposures in a high dynamic range (HDR) acquisition scheme may be captured. By way of a non-limiting example, three gated exposures c₁, c₂, c₃ with the same profile and two additional passive images without illumination, that is, c₄=c₅=0, and HDR like fixed exposure times 21 μs and 108 μs at daytime and 805 μs and 1745 μs at night time, may be used to recover depth simultaneously from stereo-gated slices and passive stereo intensity cues with the same gated-stereo camera setup. By way of a non-limiting example, the gated-stereo camera setup proposed herein may capture images at 120 Hz, natively, allowing for a per-frame update of 24 Hz, which is about 2× the update rate of the currently known commercial scanning LiDAR systems, e.g., Luminar Hydra or Velodyne Alpha Puck.

Depth from Gated Stereo

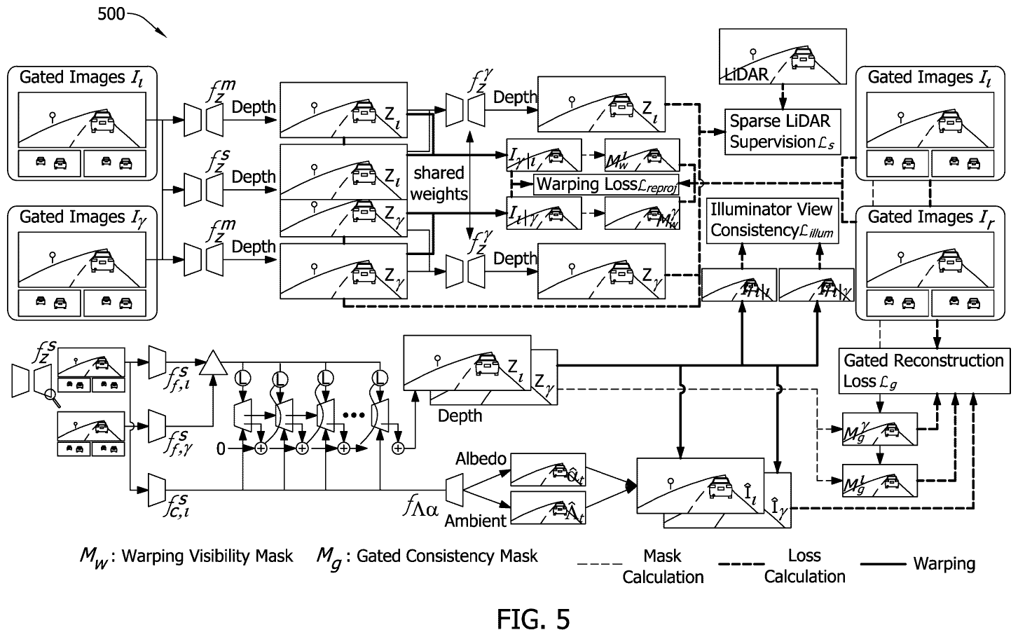

In some embodiments, a depth estimation method that is based upon active and passive multi-view cues from gated images may be used in a joint stereo and monocular network. The joint stereo and monocular network that is semi-supervised using several consistency losses tailored to gated stereo data. An architecture of the joint stereo and monocular network is described in FIG. 5 below.

FIG. 5 is an example architecture 500 including a stereo (f_{z}^{s}), two monocular (f_{z}^{m}) and two fusion (f_{z}^{r}) networks with a shared weight. The fusion network combines the output of the monocular and stereo networks to obtain the final depth image for each view. Both stereo and monocular networks use active and passive slices as input, with the stereo network using the passive slices as context and includes a decoder (f_{Λ}α) for albedo and ambient estimation that are used for gated reconstruction. Additionally, the loss terms may be applied to the appropriate pixels using masks that are estimated from the inputs and outputs of the networks. The stereo and monocular branches and the final fusion network thus combines the outputs from the stereo and monocular branches to produce the final depth map.

### Monocular Branch

The monocular network or monocular branch shown in FIG. 5, f_{z}^{m}: I→z^{m}, estimates absolute depth for a single gated image I from either of the two imagers. Unlike monocular RGB images, monocular gated images encode depth dependent intensities, which can be used by monocular depth networks to estimate scale-accurate depth maps. The monocular gated network uses a dense prediction transformer (DPT)-type architecture and outputs inverse depth bounded in [0,1] which results in absolute depth between [1, ∞].

### Stereo Branch

The stereo network or stereo branch shown in FIG. 5, f_{z}^{s}: (Iₗ, lᵣ)→(zₗ^{s}, zᵣ^{s}), estimates disparity from a pair of stereo images and outputs the depth for the left and right images zₗ and zᵣ, respectively. By way of a non-limiting example, the stereo network may be based on RAFT-stereo with all three active gated slices and two passive captures concatenated to a 5-dimensional input. The feature extractor may be replaced with a high-resolution transformer (HRFormer), which extracts robust high-resolution features for downstream stereo matching. The left and right slice features f_{f,l}^{s} and f_{f,r}^{s} are provided as input to the correlation pyramid module and the context feature f_{c,l}^{s} are used as input for the gated recurrent unit (GRU) layers shown in FIG. 5 in the bottom-left area. Further, the context features are fed to a decoder (f_{Λ}α) to estimate the albedo and ambient components for gated slice reconstruction.

### Stereo-Mono Fusion

Monocular gated depth estimates suffer from depth quantization due to the depth binning of gated slices, failure in the presence of strong ambient illumination, and illuminator occlusion. Stereo methods, in isolation, suffer from inherent ambiguity in partially occluded regions and may fail when one of the views is completely obstructed, e.g., by lens occlusions and bright illumination. Instead of distilling the monocular network with the stereo output, and distilling the stereo network with fused pseudo-labels, a lightweight 4-layer deep residual convolutional neural network (ResUNet), f_{z}^{r}: (z^{m}, z^{s}, I)→z^{f}, that takes in monocular and stereo depth with the corresponding active and passive slices as input and produce as single fused depth map as output. The active and passive slices provide additional cues for the fusion network.

In some embodiments, in addition to the depth estimation network shown in FIG. 5, a set of stereo and monocular semi-supervised training signals may be used for actively illuminated gated stereo pairs along with high dynamic passive captures.

### Depth and Photometric Consistency

In some embodiments, self-supervised consistency losses and sparse supervised losses may be used for generating depth maps.

### Left-Right Reprojection Consistency

As described herein, left-right reprojection consistency loss enforces the photometric consistency between the left and right gated images for per-pixel disparity as shown in Eq. 4 below:

$${ℒ}_{repro j} = {ℒ}_{p} ( {M}_{l \vert r}^{0} ⊙ {I}_{l} , {M}_{l \vert r}^{0} ⊙ {I}_{l \vert r} ) , \qquad Eq . 4$$

In Eq. 4, I_{l|r} the least image warped into the right view using the predicted disparity dₗ. Further, [symbol] represents a similarity loss based on the structural similarity (SSIM) metric and the L₁ norm,

$${ℒ}_{p} ( a , b ) = 0.85 \frac{1 - SSIM ( ab )}{2} + 0.15 {‖ a - b ‖}_{1} .$$

The occlusion mask M_{l|r}⁰ indicates pixels in the left image that are occluded in the right image and is defined as a soft mask for better gradient flow, M_{l|r}⁰=1−exp(−η|dₗ+d_{l|r}|), where dₗ is the left disparity and d_{l|r} is the disparity of the right image projected to the left view.

### Stereo-Mono Fusion Loss

The mono-stereo fusion loss [symbol] guides the fusion network at depth discontinuities with the occlusion mask to obtain a fused depth map, \tilde{z}_{f}=M_{l|r}⁰z^{m}+(1−M_{l|r}⁰)z^{s}, using the loss shown in Eq. 5 below.

$${ℒ}_{ms} = ‖ {z}_{f} - {\tilde{z}}_{f} {‖}_{1} , \qquad Eq . 5$$

### Ambient Image Consistency

The ambient luminance in a scene can vary by 14 orders of magnitude, inside a dark tunnel with bright sun at a tunnel exit. In order to tackle extreme dynamic range, the ambient Λ^{ko} in the scene from the short exposure slice μₖ, and sample Λ^{HDR} from HDR passive captures I⁴, I⁵. Novel scene images Îᵥ^{k} can be expresses using Eq. 6 to Eq. 8 below:

$${Λ}_{v}^{HDR} = {μ}_{s} ( {I}_{v}^{4} + {I}_{v}^{5} - {D}_{v}^{4} - {D}_{v}^{5} ) / ( {μ}_{4} + {μ}_{5} ) , \qquad Eq . 6$$

$${Λ}_{v}^{ko} = {μ}_{k} ( {I}_{v}^{4} + {I}_{v}^{5} - {D}_{v}^{4} - {D}_{v}^{5} ) / ( {μ}_{4} + {μ}_{5} ) , \qquad Eq . 7$$

$${\hat{I}}_{v}^{k} = clip ( {I}_{v}^{k} - {Λ}_{v}^{ko} + {Λ}_{v}^{HDR} , 0 , {2}^{10} ) , \qquad Eq . 8$$

In above Eq. 6 and Eq. 7, μₛ is uniformly sampled in the interval from [0.5μₖ, 1.5μₖ]. Further, the network shown in FIG. 5 may be supervised by enforcing the depth to be consistent across different illumination levels.

### Gated Reconstruction Loss

In some embodiments, cyclic gated reconstruction loss from measured range intensity profiles cₖ(z) may be used to reconstruct the input gated images from the predicted depth z, the albedo \tilde{α} and the ambient \tilde{Λ}. The albedo \tilde{α} and the ambient \tilde{Λ} may be estimated from the context encoder through an additional deep convolutional neural network (U-Net) like decoder shown in FIG. 5. As described herein, the consistency loss may model a gated slice as Eq. 9 below:

$${\tilde{I}}^{k} ( z ) = \tilde{α} {c}_{k} ( z ) + \tilde{Λ} , \qquad Eq . 9$$

The loss term may be based on the per-pixel difference and structural similarity as follows,

$${ℒ}_{recon} = {ℒ}_{p} ( {M}_{g} ⊙ {\tilde{I}}^{k} ( z ) , {M}_{g} ⊙ {I}^{k} ) + {ℒ}_{p} ( \tilde{Λ} , {Λ}^{ko} ) , \qquad Eq . 10$$

Accordingly, per-pixel SNR may be utilized to obtain the gated consistency mask M_{g}. The gated reconstruction loss enforces that the predicted depth is consistent with the simulated gated measurements.

### Illuminator View Consistency

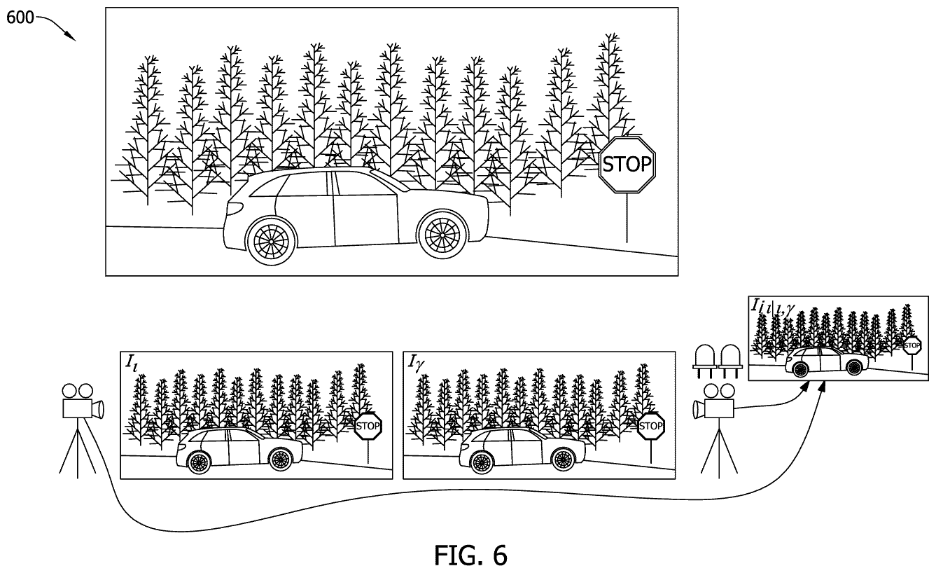

In some embodiments, additional depth consistency from the illuminator field of view may be enforced for the gated stereo setup shown in FIG. 5. FIG. 6 is an example illustration 600 of scene regions occluded in an illuminator view in shadow in the two views shown on the left and middle in the bottom section of FIG. 6. A shadowless view is shown as being projected to the illuminator viewpoint on the right in the bottom section of FIG. 6. In FIG. 6, no shadows are visible in the virtual camera view, which effectively makes the regions that are visible to the two cameras and the illuminator consistent. The gated consistency mask M_{g} may be used to supervise only regions that are illuminated by the laser and project the gated views I_{l,r} into the laser field of view I_{il|r,l}, resulting in the loss,

$${ℒ}_{illum} = {ℒ}_{p} ( {M}_{g} ⊙ {I}_{il \vert l} , {M}_{l \vert r}^{0} ⊙ {I}_{il \vert r} ) , \qquad Eq . 11$$

### Image Guided Depth Regularization

In some embodiments, to the binocular and multi-view stereo methods, an edge-aware smoothness loss [symbol] as regularization to the mean normalized inverse depth estimated d, as Eq. 12 below.

$${ℒ}_{smooth} = \vert {▽}_{x} d \vert {e}^{- \vert {▽}_{x} I \vert} + \vert {▽}_{y} d \vert {e}^{- \vert {▽}_{y} I \vert} , \qquad Eq . 12$$

### Sparse LiDAR Supervision

In some embodiments, the gated stereo system described using FIG. 5 and FIG. 6 may have a higher update rate, e.g., 24 Hz, than typical scanning LiDAR that is 10 Hz. Sparse LiDAR supervision can be applied to samples fully in sync while all the previously presented self-supervised losses are applied to all samples. The LiDAR returns are compensated for ego-motion (or motion of a vehicle with the installed LiDAR sensor) and projected onto the image space. The supervision loss [symbol] for view v is as shown in Eq. 13 below.

$${ℒ}_{sup} = {M}_{v \vert s} ⊙ ‖ {z}_{v} - {z}_{v \vert s}^{*} {‖}_{1} , \qquad Eq . 13$$

In Eq. 13 above, M_{v|s} is a binary mask indicating the projection of LiDAR points on the image and z_{v|s}* is the ground-truth depth from a single LiDAR scan projected onto the image v.

### Overall Training Loss

In some embodiments, all self-supervised and supervised loss components described above may be combined to arrive at the following loss terms,

$${ℒ}_{sup} = {c}_{1} {ℒ}_{recon} + {c}_{2} {ℒ}_{sup} + {c}_{3} {ℒ}_{smooth} , \qquad Eq . 14$$

$${ℒ}_{stereo} = {c}_{4} {ℒ}_{repro j} + {c}_{5} {ℒ}_{recon} + {c}_{6} {ℒ}_{rillum} + {c}_{7} {ℒ}_{sup} + {c}_{8} {ℒ}_{smooth} , \qquad Eq . 15$$

$${ℒ}_{fusion} = {c}_{9} {ℒ}_{ms} + {c}_{10} {ℒ}_{sup} + {c}_{11} {ℒ}_{smooth} , \qquad Eq . 16$$

In Eq. 14 through Eq. 16, c₁, . . . c₁₁ are scalar weights.

### Example Setup and Implementation Details

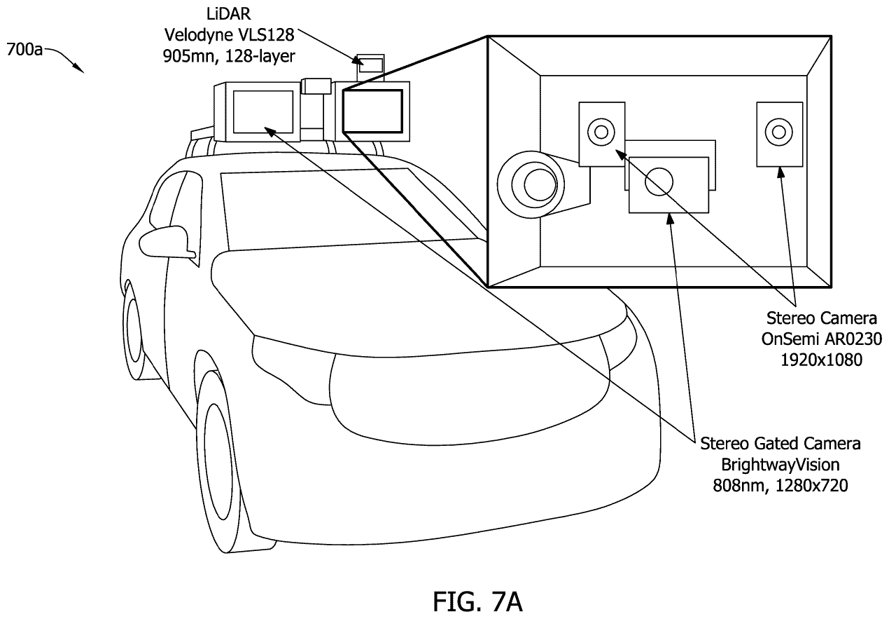

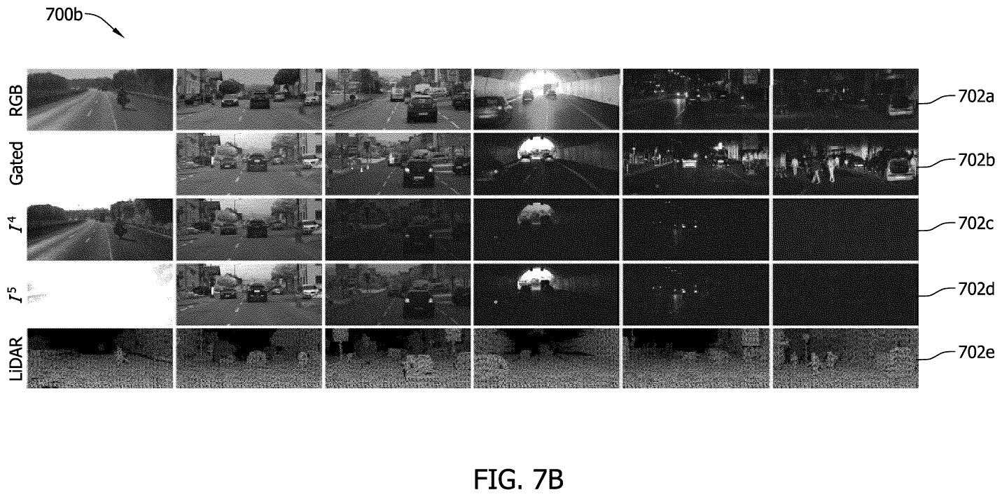

In some embodiments, FIG. 7A illustrates an example sensor setup 700a and FIG. 7B illustrates example captures 700b from the wide-base gated stereo dataset. In FIG. 7B, from top to bottom, RGB 702a, gated 702b with red for slice 1, green for slice 2, and blue for slice 3, gated passive 702c with low exposure time I⁴, gated passive 702d with high exposure time I⁵, and LiDAR 702e are shown. By way of a non-limiting example, availability of a large number of frames with αcₖ<I^{k}.

In some embodiments, the monocular and stereo networks may be optimized independently using the losses presented above by Eq. 14, Eq. 15, and Eq. 16. Both the stereo and monocular networks may be trained using the same protocol using a stochastic optimization method that modifies the typical implementation of weight decay in an adaptive learning rate optimization algorithm that utilizes both momentum and scaling and referenced herein as ADAMW. The protocol using the ADAMW may have β₁=0.9, β₂=0.999, and learning rate of 10⁻⁴. Additionally, η=0.05 may be for generating occlusion masks referenced herein in Eq. 4. For gated consistency masks, γ=0.98 and θ=0.04 may be used. Further, both the stereo and monocular networks may be trained with input/output resolution of 1024×512.

### Dataset

In some embodiments, a long-range depth dataset may be used for both training and testing. The dataset may be acquired, for example, during a data collection campaign covering more than one thousand kilometers of driving in urban, suburban, and highway environments. Data of the dataset may be collected using a testing vehicle or an ego vehicle equipped with, for example, a long-range LiDAR system (Velodyne VLS128) with a range of up to 200 m, an automotive RGB stereo camera (e.g., On-Semi AR0230 sensor), and a near-infrared (NIR) gated stereo camera setup (e.g., BrightWayVision) with synchronization. The sensor setup may be as shown in FIG. 7 with all sensors, except the LiDAR sensor, may be mounted in a portable sensor cube. The RGB stereo camera may have a resolution of 1920×1080 pixels and run at 30 Hz capturing 12 bit HDR images. The gated camera may provide 10 bit images with a resolution of 1280×720 at a framerate of 120 Hz, which may be split up into three slices plus two HDR-like additional ambient captures without active illumination. Two vertical-cavity surface-emitting laser (VCSEL) modules may be used as active illumination mount on a front tow hitch of the testing vehicle or ego vehicle.

In some embodiments, and by way of a non-limiting examples, the lasers flood may illuminate the scene at a peak power of 500 W each, a wavelength of 808 nm and laser pulse durations of 240-370 ns. The maximum peak power may thereby be limited due to eye-safety regulations. The mounted reference LiDAR system may be running at 10 Hz and yield 128 lines. All sensors may be calibrated, and time synchronized, and visual examples may be as shown in FIG. 7. The dataset may include about 107348 samples in day, nighttime, and varying weather conditions. After sub-selection of scenario diversity, the dataset may be split into a first subset of samples for training, a second subset of samples for validation, and a third subset of samples for testing. By way of a non-limiting example, the first subset of samples may include about 54320 samples, the second subset of samples may include about 728 samples, and the third subset of samples may include about 2463 samples.

In some embodiments, for the test setup including about 2463 (1269 day/1194 night) frame with high resolution 128-layer LiDAR ground-truth measurements up to 200 m. In contrast to ground-truth measurements limited to 80 m for the currently known test setups, results up to a distance of 160 m to assess long-range depth prediction may be reported. Additionally, depth using the metrics root mean square error (RMSE), mean absolute error (MAE), absolute relative difference (ARD), and δᵢ<1.25i for i∈1, 2, 3 and split results for day and night. Further, all compared methods are fine-tuned using the same dataset for fair comparison. Methods of fine-tuning are described herein above while describing the joint stereo-mono depth network, monocular and stereo branches, and stereo-mono fusion with regards to FIG. 5.

### Depth Reconstruction

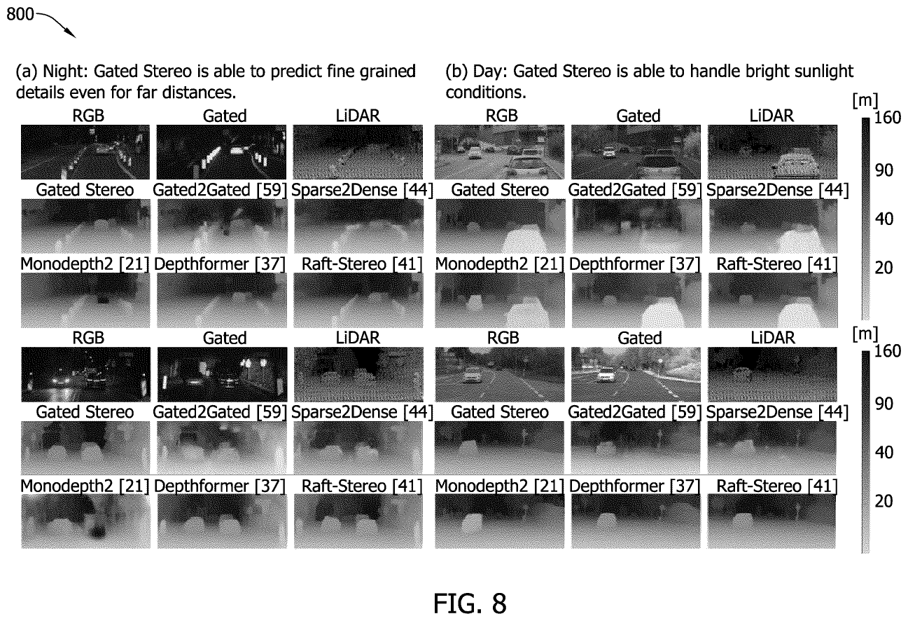

FIG. 8 is an example representation 800 of qualitative comparison of gated stereo as described herein in accordance with some embodiments and currently known methods. As it can been seen the example representation 800, for the (a) night conditions and (b) day conditions, using gated stereo methods in the present disclosure may produce or predict sharper depth maps than the currently known methods. In the gated images shown in FIG. 8, red refers to I¹, green refers to I², and blue refers to I³.

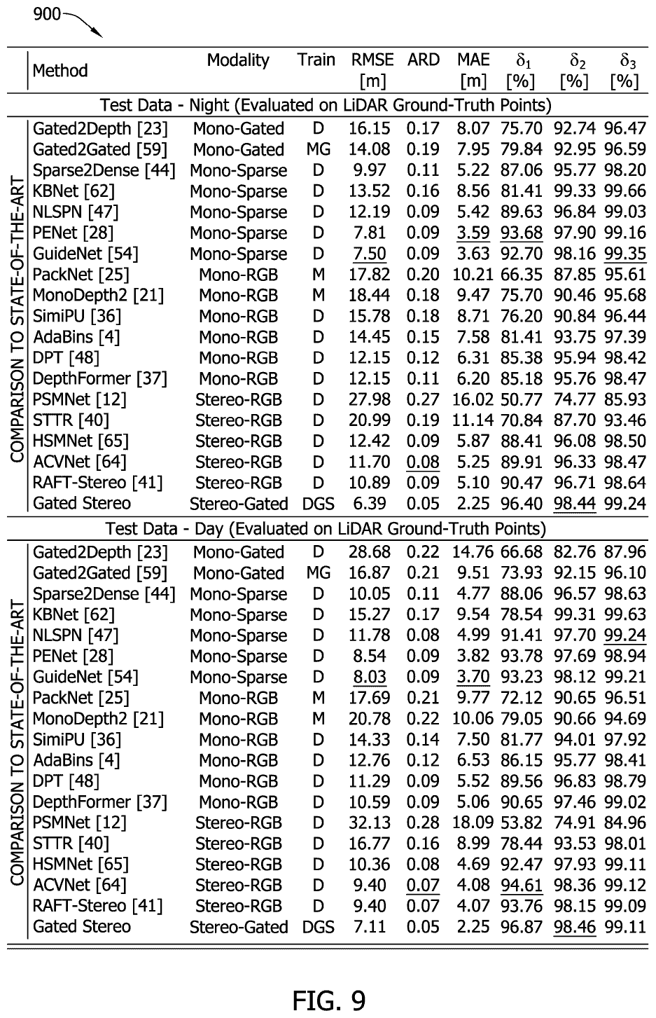

FIG. 9 is an example representation 900 of quantitative results showing comparison of framework described in the present disclosure according to some embodiments and currently known state-of-the-art methods on the gated stereo test dataset. Additionally, supervised, and unsupervised approaches are compared, in which M refers to methods that use temporal data for training, S for stereo supervision, G for gated consistency and D for depth supervision. Methods marked with * are scaled with LiDAR ground-truth, and best results in each category are shown as in bold and second best results are underlined.

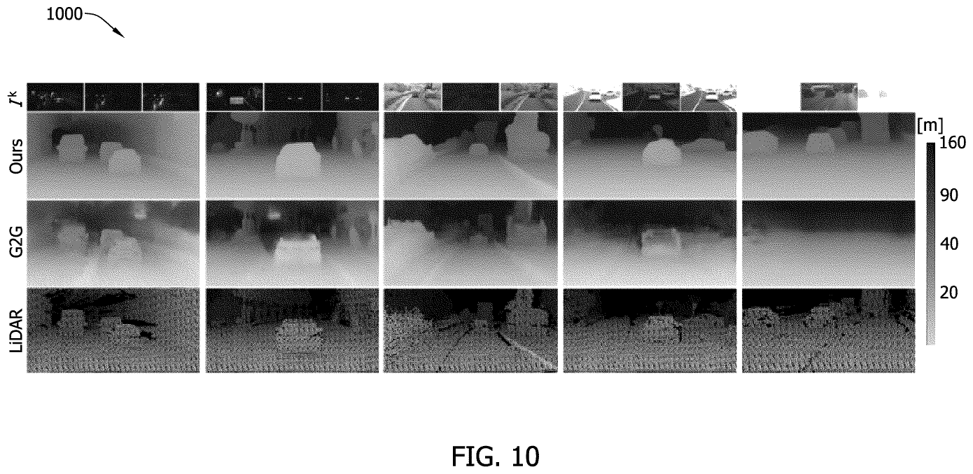

In some embodiments, two recent gated, six monocular RGB, five stereo RGB, and five monocular+LiDAR methods are compared against each other. Comparing gated stereo to the next best stereo method RAFT-Stereo, gated stereo methods may reduce error by about 45% and 1.8 m in MAE in day conditions. In night conditions, the error may be reduced by about 56% and 2.9 m in MAE. Qualitatively this improvement is visible in sharper edges and less washed-out depth estimates. Fine details, including thin poles, are better visible due to structure-aware refinement achieved through the monocular depth outputs. The next best gated method, Gated2Gated may achieve about a 9.51 m MAE in day conditions and about a 7.95 m MAE in night conditions. In this case of Gated2Gated method, performance drops significantly in day conditions due to strong ambient illumination, while gated stereo is capable of making use of the passive captures, as shown in FIG. 10, showing qualitative comparison, where gated stereo maintains high quality depth outputs, while Gated2Gated method fails.

FIG. 10 is an example view 1000 in which the top row for each example shows the concatenated gated image I^{1,2,3} and the corresponding passive images I⁴ and I⁵. The second row shows the depth map of the stereo gated method described herein according to some embodiments and the third row shows results of the Gated2Gated (G2G) method, and the bottom row depicts the projected LiDAR point cloud into the gated view. The stereo gated method described herein according to some embodiments handles shadow areas and high reflectivity targets between that G2G. Additionally, the HDR input may allow to predict accurate depth even in bright conditions. Overall, a reduction of about 74% in MAE error compared to existing known gated methods may be realized. In comparison with the best monocular RGB method, e.g., Depthformer, textures are often wrongly interpreted as rough surfaces missing smoothness. Lastly, the stereo gated method described herein according to some embodiments when compared with monocular+LiDAR methods, the monocular+LiDAR methods fed with ground-truth points may achieve competitive quantitative results on par with the best stereo methods.

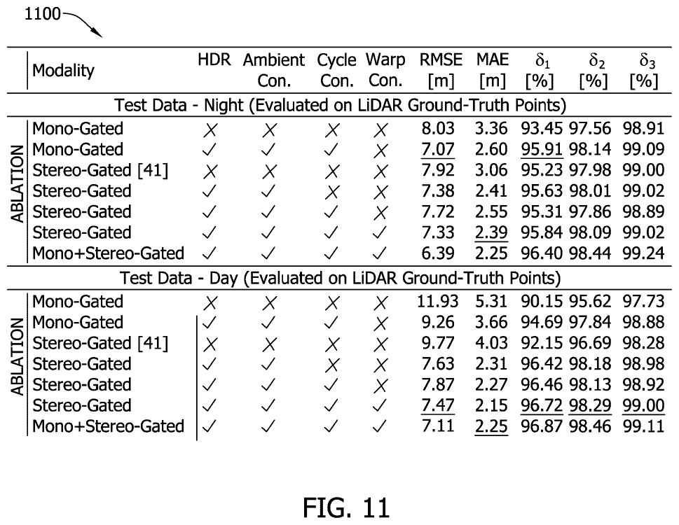

FIG. 11 is an example table 1100 that reports ablation experiments to validate contributions of each component of the stereo gated method described herein according to some embodiments. Ablation experiments evaluate the gated stereo test dataset described herein in different input modalities, feature encoders, and loss combinations for the monocular and stereo network. As it can be seen from the table 1100, final fusion model corresponding to the Mono+Stereo-gated outperforms all other methods shown in the table 1100 by a significant margin.

In some embodiments, the MAE of the different models averaged over day and night may be compared in which the starting point may be the monocular gated estimation using the proposed monocular branch with LiDAR supervision only. Monocular gated estimation using the monocular branch with LiDAR supervision outperforms the best monocular RGB approach by about 23% lower MAE error. Further, the concatenated passive images and the active slices may result in an added reduction of about 28% MAE error. When RAFT-Stereo is analyzed with stereo gated images and HDR-like passive frames as input, and with additional ambient aware consistency and the proposed backbone in the present disclosure, the MAE may be reduced by about 25% compared to the next monocular gated approach and by about 36% to a native RAFT-Stereo network with gated input. The HRFormer backbone alone may contribute about 10% of the approximately 33% reduction in MAE. By adding the gated consistency loss and the warping losses for left-right consistency across views and illuminator, the error may be further reduced by about 4%. Finally, the fusion stage combining the monocular and stereo outputs may preserve the fine structures from the monocular model and the long-range accuracy of the stereo model, which results in a reduction of about 48% in MAE error when compared to monocular gating.

In summary, the gated-stereo method for a long-range active multi-view depth estimation described herein predicts dense depth from synchronized gated stereo pairs acquired in a wide-baseline setup. The architecture described herein includes a stereo network and per-view monocular and stereo-mono fusion networks. The sub-networks utilize both active and passive images to extract depth cues. While stereo cues may be ambiguous, e.g., due to occlusion and repeated structure, and monocular gated cues may be insufficient in bright ambient illumination and at long-range, the gated-stereo method described herein predicts stereo ad per-camera monocular depth and finally fuses the two to obtain a single high-quality depth map. Different parts of the network (e.g., the network shown in FIG. 5) are semi-supervised with sparse LiDAR supervision and a set of self-supervised losses that ensure consistency between different predicted outputs. The gated-stereo method is trained and validated using a long-range automotive dataset with a maximum depth range twice as long as currently available datasets. The gated-stereo method described herein achieves about 50% better mean absolute depth error than the next best method on stereo RGB images and about 74% better mean absolute depth error compared to the next best existing gated method.

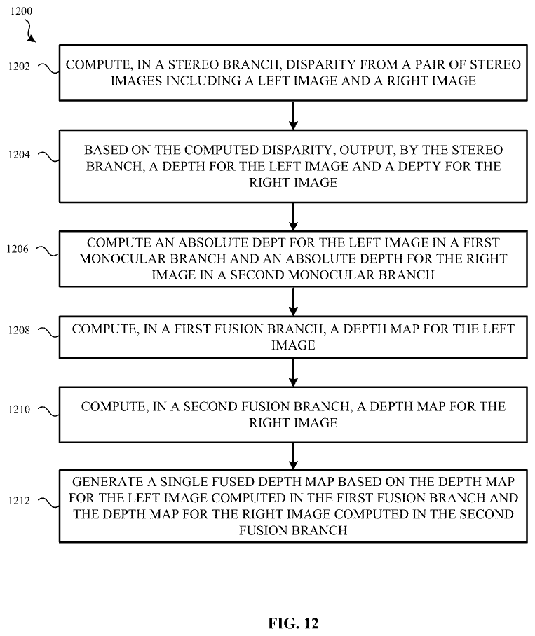

FIG. 12 illustrates an exemplary flow-chart 1200 of method operations performed by a perception system or an autonomy computing system shown in FIG. 2 or FIG. 3. The method operations may include computing 1202 disparity from a pair of stereo images in a stereo branch shown in FIG. 5. The stereo images include a left image and a right image, which are generated based on sensor data of a plurality of image sensors. The plurality of image sensors includes at least two image sensors (or a stereo camera) or LiDAR sensors. By way of a non-limiting example, the image sensors may include a RGB stereo camera of a near-infrared (NIR) gated stereo camera.

The method operations may include outputting 1204, by the stereo branch, a depth computed for the left image and a dept computed for the right image, as described herein. Further, as described herein, the stereo branch includes a decoder for albedo and ambient illumination estimation for gated reconstruction. The method operations may include computing 1206 an absolute depth for the left image in a first monocular branch and an absolute depth for the right image in a second monocular branch. The first monocular branch and the second monocular branch are shown in FIG. 5 and computing the absolute depth for the left image and the absolute depth for the right image are described in detail using FIG. 5 above.

The method operations may include computing 1208 a depth map for the left image in a first fusion branch. The depth map for the left image may be computed 1208 by combining a depth output for the left image from the stereo branch and the absolute depth for the left image from the first monocular branch. The method operations may include computing 1210 a depth map for the right image in a second fusion branch. The depth map for the right image may be computed 1210 by combining a depth output for the right image from the stereo branch and the absolute depth for the right image from the second monocular branch. A single fused depth map may be generated 1212 based on the depth map for the left image computed in the first fusion branch and the depth map for the right image computed in the second fusion branch.

Each of the stereo branches, the first monocular branch, and the second monocular branch is optimized for respective self-supervised and supervised loss components. Additionally, the first fusion branch and the second fusion branch are optimized for self-supervised and supervised loss components. The self-supervised or supervised loss components include one or more of: a supervision loss, an edge-aware smoothness loss, an illuminator view consistency loss, a gated reconstruction loss, a stereo-mono fusion loss, or a left-right reprojection consistency loss. Further, the stereo branch, the first monocular branch, the second monocular branch, the first fusion branch or the second fusion branch is trained using a stochastic optimization method that modifies a weight decay for an adaptive learning rate optimization algorithm based at least in part upon a momentum and scaling.

Various functional operations of the embodiments described herein may be implemented using machine learning algorithms, and performed by one or more local or remote processors, transceivers, servers, and/or sensors, and/or via computer-executable instructions stored on non-transitory computer-readable media or medium.

In some embodiments, the machine learning algorithms may be implemented, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques.

In some embodiments, various functional operations of the embodiments described herein may be implemented using an artificial neural network model. The artificial neural network may include multiple layers of neurons, including an input layer, one or more hidden layers, and an output layer. Each layer may include any number of neurons. It should be understood that neural networks of a different structure and configuration may be used to achieve the methods and systems described herein.

In the exemplary embodiment, the input layer may receive different input data. For example, the input layer includes a first input a₁ representing training images, a second input a₂ representing patterns identified in the training images, a third input a₃ representing edges of the training images, and so on. The input layer may include thousands or more inputs. In some embodiments, the number of elements used by the neural network model changes during the training process, and some neurons are bypassed or ignored if, for example, during execution of the neural network, they are determined to be of less relevance.

In some embodiments, each neuron in hidden layer(s) may process one or more inputs from the input layer, and/or one or more outputs from neurons in one of the previous hidden layers, to generate a decision or output. The output layer includes one or more outputs each indicating a label, confidence factor, weight describing the inputs, an output image, or a point cloud. In some embodiments, however, outputs of the neural network model may be obtained from a hidden layers in addition to, or in place of, output(s) from the output layer(s).

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In some embodiments, the layers may not be clearly delineated in terms of the functionality they perform. For example, two or more of hidden layers may share decisions relating to labeling, with no single layer making an independent decision as to labeling.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A perception system, comprising:
a plurality of image sensors;
at least one memory having instructions stored thereon; and
at least one processor communicatively coupled with the at least one memory and configured to execute the instructions to:
compute, in a stereo branch, disparity from a pair of stereo images including a left image and a right image, wherein the left image and the right image are generated based on sensor data of the plurality of image sensors;
based on the computed disparity from the pair of stereo images, output, by the stereo branch, a depth for the left image and a depth for the right image;
compute an absolute depth for the left image in a first monocular branch and an absolute depth for the right image in a second monocular branch;
compute, in a first fusion branch, a depth map for the left image by combining a depth output for the left image from the stereo branch and the absolute depth for the left image from the first monocular branch;
compute, in a second fusion branch, a depth map for the right image by combining a depth output for the right image from the stereo branch and the absolute depth for the right image from the second monocular branch; and
generate a single fused depth map based on the depth map for the left image computed in the first fusion branch and the depth map for the right image computed in the second fusion branch.

2. The perception system of claim 1, wherein the plurality of image sensors includes at least two light detection and ranging (LiDAR) sensors or image sensors.

3. The perception system of claim 2, wherein the image sensors include a red-green-blue (RGB) stereo camera, or a near-infrared (NIR) gated stereo camera.

4. The perception system of claim 1, wherein each of the stereo branch, the first monocular branch, and the second monocular branch is optimized for respective self-supervised and supervised loss components.

5. The perception system of claim 4, wherein the first fusion branch and the second fusion branch are optimized for the respective self-supervised and supervised loss components.

6. The perception system of claim 5, wherein the respective self-supervised or supervised loss components include one or more of: a supervision loss, an edge-aware smoothness loss, an illuminator view consistency loss, a gated reconstruction loss, a stereo-mono fusion loss, or a left-right reprojection consistency loss.

7. The perception system of claim 1, wherein the stereo branch, the first monocular branch, the second monocular branch, the first fusion branch or the second fusion branch is trained using a stochastic optimization method that modifies a weight decay for an adaptive learning rate optimization algorithm based at least in part upon a momentum and scaling.

8. The perception system of claim 1, wherein the stereo branch includes a decoder for albedo and ambient illumination estimation for gated reconstruction.

9. A computer-implemented method, comprising:
computing, in a stereo branch, disparity from a pair of stereo images including a left image and a right image, wherein the left image and the right image are generated based on sensor data of a plurality of image sensors;
based on the computed disparity from the pair of stereo images, outputting, by the stereo branch, a depth for the left image and a depth for the right image;
computing an absolute depth for the left image in a first monocular branch and an absolute depth for the right image in a second monocular branch;
computing, in a first fusion branch, a depth map for the left image by combining a depth output for the left image from the stereo branch and the absolute depth for the left image from the first monocular branch;
computing, in a second fusion branch, a depth map for the right image by combining a depth output for the right image from the stereo branch and the absolute depth for the right image from the second monocular branch; and
generating a single fused depth map based on the depth map for the left image computed in the first fusion branch and the depth map for the right image computed in the second fusion branch.

10. The computer-implemented method of claim 9, wherein the plurality of image sensors includes at least two light detection and ranging (LiDAR) sensors or image sensors.

11. The computer-implemented method of claim 10, wherein the image sensors include a red-green-blue (RGB) stereo camera, or a near-infrared (NIR) gated stereo camera.

12. The computer-implemented method of claim 9, wherein each of the stereo branch, the first monocular branch, and the second monocular branch is optimized for respective self-supervised and supervised loss components.

13. The computer-implemented method of claim 12, wherein the first fusion branch and the second fusion branch are optimized for the respective self-supervised and supervised loss components.

14. The computer-implemented method of claim 13, wherein the respective self-supervised or supervised loss components include one or more of: a supervision loss, an edge-aware smoothness loss, an illuminator view consistency loss, a gated reconstruction loss, a stereo-mono fusion loss, or a left-right reprojection consistency loss.

15. The computer-implemented method of claim 9, wherein the stereo branch, the first monocular branch, the second monocular branch, the first fusion branch or the second fusion branch is trained using a stochastic optimization method that modifies a weight decay for an adaptive learning rate optimization algorithm based at least in part upon a momentum and scaling.

16. The computer-implemented method of claim 9, wherein the stereo branch includes a decoder for albedo and ambient illumination estimation for gated reconstruction.

17. A vehicle, comprising:
a plurality of image sensors;
at least one memory having instructions stored thereon; and
at least one processor communicatively coupled with the at least one memory and configured to execute the instructions to:
compute, in a stereo branch, disparity from a pair of stereo images including a left image and a right image, wherein the left image and the right image are generated based on sensor data of the plurality of image sensors;
based on the computed disparity from the pair of stereo images, output, by the stereo branch, a depth for the left image and a depth for the right image;
compute an absolute depth for the left image in a first monocular branch and an absolute depth for the right image in a second monocular branch;
compute, in a first fusion branch, a depth map for the left image by combining a depth output for the left image from the stereo branch and the absolute depth for the left image from the first monocular branch;
compute, in a second fusion branch, a depth map for the right image by combining a depth output for the right image from the stereo branch and the absolute depth for the right image from the second monocular branch; and
generate a single fused depth map based on the depth map for the left image computed in the first fusion branch and the depth map for the right image computed in the second fusion branch.

18. The vehicle of claim 17, wherein the plurality of image sensors includes at least two light detection and ranging (LiDAR) sensors or image sensors, wherein the image sensors include a red-green-blue (RGB) stereo camera, or a near-infrared (NIR) gated stereo camera.

19. The vehicle of claim 17, wherein each of the stereo branch, the first monocular branch, and the second monocular branch is optimized for respective self-supervised and supervised loss components, and wherein the first fusion branch and the second fusion branch are optimized for self-supervised and supervised loss components.

20. The vehicle of claim 19, wherein the self-supervised or supervised loss components include one or more of: a supervision loss, an edge-aware smoothness loss, an illuminator view consistency loss, a gated reconstruction loss, a stereo-mono fusion loss, or a left-right reprojection consistency loss, and wherein the stereo branch, the first monocular branch, the second monocular branch, the first fusion branch or the second fusion branch is trained using a stochastic optimization method that modifies a weight decay for an adaptive learning rate optimization algorithm based at least in part upon a momentum and scaling.
